(19) United States
(12) Patent Application Publication
(10) Pub. No.: US 2020/0267346 A1
(43) Pub. Date: Aug. 20, 2020

(54) Selfie short video greeting card

(71) Applicant: Wattly International Group Ltd., Sheung Wan (HK)

(72) Inventor: Tsen Yin Sun, Sheung Wan (HK)

(73) Assignee: Wattly International Group Ltd., Sheung Wan (HK)

(21) Appl. No.: 16/732,602

(22) Filed: Jan. 2, 2020

(30) Foreign Application Priority Data
Feb. 14, 2019 (CN) 201920198198.7

(51) Int. Cl. H04N 5/77; G06F 3/02; G06F 3/147

(52) U.S. Cl. CPC H04N 5/772; H02J 7/0045; G06F 3/147; G06F 3/0202

(57) ABSTRACT

A selfie short video greeting card is disclosed, comprising a body provided with a video recording unit, a voice recording unit, a display unit, a sounding unit, a power source, a storage unit, and a control unit. An input end of the video recording unit is connected to the storage unit. An output end of the voice recording unit is connected to the storage unit. An output end of the storage unit is connected to the display unit and the sounding unit. The video recording unit, voice recording unit, display unit, sounding unit, power source, and storage unit are all connected to the control unit. It has a simple structure, low cost, and light weight. A 15-second video with sensible facial expressions and tones can be recorded, and people can feel deep greetings expressed by friends and relatives more conveniently, which is interesting.

### TECHNICAL FIELD

The present invention relates to the field of electronic technologies, and in particular, to a selfie short video greeting card.

### BACKGROUND

Greeting cards are originated from human social needs. The greeting cards are used for emotional communication between persons, and such communication is often expressed by short sentences, thus being concise and comprehensive. As time goes by, stylized greeting words for celebration have appeared, and auspicious words are sent to each other to convey people's expectations for life and hope for today.

However, the form of the greeting cards is single, and deep wishes of friends or relatives cannot be fully expressed through written words. In addition, most greeting cards are made of paper materials, which can only be used once, resulting in excessive waste of materials.

### SUMMARY

An objective of the present invention is to provide a selfie short video greeting card.

In order to achieve the above objective, the following technical solution is provided in the present invention: a selfie short video greeting card, comprising a body provided with a video recording unit, a voice recording unit, a display unit, a sounding unit, a power source, a storage unit, and a control unit, wherein an input end of the video recording unit is connected to the storage unit; an output end of the voice recording unit is connected to the storage unit; an output end of the storage unit is connected to the display unit and the sounding unit; and the video recording unit, the voice recording unit, the display unit, the sounding unit, the power source, and the storage unit are all connected to the control unit.

Further, the power source comprises a rechargeable battery and a USB charging plug; and the USB charging plug is connected to the rechargeable battery.

Further, the body is a paper shell; a first opening and a second opening are provided on an operating interface of the paper shell; the display unit comprises a display screen located in the first opening; and the USB charging plug is located in the second opening.

Further, the paper shell is provided with a paper flip cover plate; one end of the paper flip cover plate is integrally connected to the paper shell; when the paper flip cover plate is folded, the paper flip cover plate is fitted on the operating interface of the paper shell; and when the paper flip cover plate is unfolded, the paper flip cover plate is separated from the operating interface of the paper shell.

Further, the paper flip cover plate is provided with a third opening aligned with the first opening; and when the paper flip cover plate is folded, an edge of the first opening is flush with an edge of the third opening.

Further, the control unit comprises a circuit board, a first control key, and a second control key; the first control key and the second control key are both connected to the circuit board; the first control key is configured to control device startup and video recording; the second control key is configured to turn on the recorded video; and the first control key and the second control key are located at the operating interface of the paper shell.

Further, the display screen is an LCD screen.

Further, the paper shell is a hollow plate-like structure; the first opening is located on an upper surface of the plate-like structure; and the second opening is located on a side of the plate-like structure.

The present invention has the following technical effects: it has a simple structure, low cost, and light weight. It can be used multiple times, thus saving materials and being convenient in operation. A 15-second video with visible facial expressions and hearable tones can be recorded, and people can feel deep greetings expressed by friends and relatives more conveniently, which is interesting.

### DESCRIPTION OF THE DRAWINGS

FIG. 1 is a schematic structural diagram of a paper shell (folded) according to an embodiment;

FIG. 2 is a schematic structural diagram of a paper shell (unfolded) according to an embodiment;

FIG. 3 is a positional relation diagram of a second opening according to an embodiment; and

FIG. 4 is a schematic diagram of control according to an embodiment.

Reference numerals: 1. paper shell; 11. operating interface; 12. first opening; 13. second opening; 2. paper flip cover plate; 21. third opening; 3. LCD screen; 4. USB charging plug; 5. first control key; 6. second control key.

### DETAILED DESCRIPTION

The technical solutions in embodiments of the present invention will be clearly and completely described in the following with reference to the accompanying drawings in the embodiments of the present invention. It is apparent that the embodiments described are merely some rather than all the embodiments of the present invention. All other embodiments obtained by those of ordinary skill in the art based on the embodiments in the present invention without creative efforts shall be encompassed in the protection scope of the present invention.

### EMBODIMENT

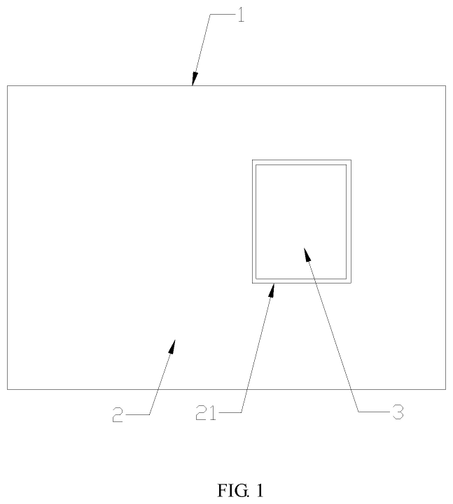

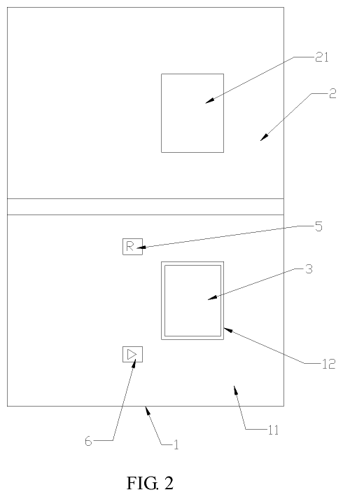

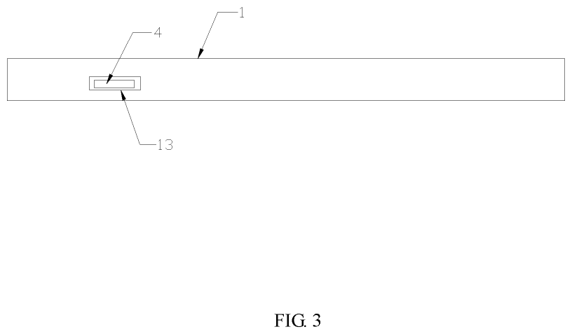

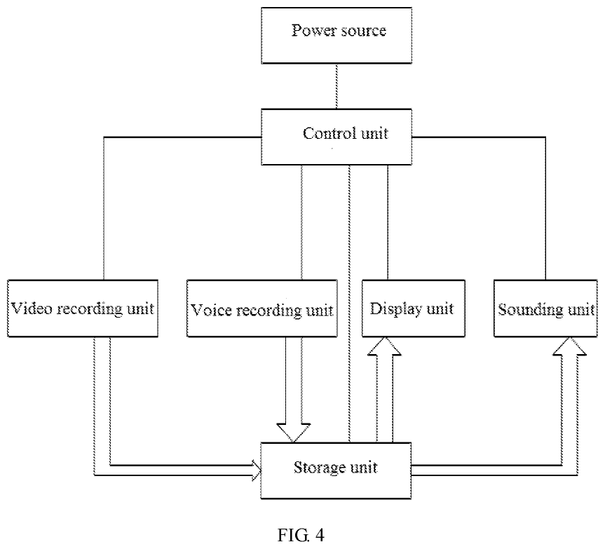

As shown in FIG. 1 to FIG. 4, a selfie short video greeting card includes a body provided with a video recording unit, a voice recording unit, a display unit, a sounding unit, a power source, a storage unit, and a control unit. An input end of the video recording unit is connected to the storage unit. An output end of the voice recording unit is connected to the storage unit. An output end of the storage unit is connected to the display unit and the sounding unit. The video recording unit, the voice recording unit, the display unit, the sounding unit, the power source, and the storage unit are all connected to the control unit.

The video recording unit and the voice recording unit store recorded video and audio in the storage unit at the same time respectively. The display unit and the sounding unit are configured to synchronously play back the video and audio stored in the memory. The control unit is configured to control the work of each part.

The power source includes a rechargeable battery and a USB charging plug 4. The USB charging plug 4 is connected to the rechargeable battery. The rechargeable battery can be charged by connecting to an external power source through a data line, which can be used multiple times conveniently and can record different videos.

The body is a paper shell 1. A first opening 12 and a second opening 13 are provided on an operating interface 11 of the paper shell 1. The display unit includes a display screen located in the first opening 12. The USB charging plug 4 is located in the second opening 13.

The paper shell 1 is provided with a paper flip cover plate 2, and one end of the paper flip cover plate 2 is integrally connected to the paper shell 1. When the paper flip cover plate 2 is folded, the paper flip cover plate 2 is fitted on the operating interface 11 of the paper shell 1 to cover the second opening 13, thus avoiding dust from entering the second opening 13 to damage the internal structure. When the paper flip cover plate 2 is unfolded, the paper flip cover plate 2 is separated from the operating interface 11 of the paper shell 1.

The paper flip cover plate 2 is provided with a third opening 21 aligned with the first opening 12. When the paper flip cover plate 2 is folded, an edge of the first opening 12 is flush with an edge of the third opening 21. When a video is watched, it can also be watched normally after the paper flip cover plate 2 is folded, thus saving the operation space.

The control unit includes a circuit board, a first control key 5, and a second control key 6. The first control key 5 and the second control key 6 are both connected to the circuit board. The first control key 5 is configured to control device startup and video recording, and the second control key 6 is configured to turn on recorded video. The first control key 5 and the second control key 6 are located at the operating interface 11 of the paper shell 1. When the paper flip cover plate 2 is folded, the first control key 5 and the second control key 6 are covered to prevent people from accidentally touching the first control key 5 and the second control key 6.

Preferably, the display screen is an LCD screen 3. The video recording unit includes a camera configured to record a video and store the recorded video in a memory. The voice recording unit includes a microphone configured to record audio synchronously and store the audio in the memory. The display unit includes a display screen, which may be an LCD screen 3 configured to display the video in the memory. The sounding unit includes a speaker configured to play back the corresponding audio in the memory while playing back the video. The structure is simple and the cost is low.

The paper shell 1 is a hollow plate-like structure. The first opening 12 is located on an upper surface of the plate-like structure, and the second opening 13 is located on a side of the plate-like structure, which is convenient for an operator to use and charge and does not occupy too much space.

When a video needs to be recorded, an operation manner is as follows.

1. The paper flip cover plate 2 is opened, the first control key 5 is pressed for 3 seconds to boot the device.

2. The first control key 5 is pressed once to be ready for recording.

3. The first control key 5 is pressed once again to start recording.

4. The second control key 6 is pressed to view the recorded video.

When a video needs to be viewed, an operation manner is as follows.

1. The paper flip cover plate 2 is opened, the first control key 5 is pressed for 3 seconds to boot the device.

2. The second control key 6 is pressed to view the recorded video.

When charging is required, the paper flip cover plate 2 is opened, one end of a data line is connected to the USB charging plug 4, the other end of the data line is connected to an external power source, and then the rechargeable battery can be charged, which can be used multiple times conveniently. Different videos can be recorded, the use cost is low, and it is highly interesting.

In conclusion, the present invention can be better implemented.

1. A selfie short video greeting card, comprising a body (1) provided with a video recording unit, a voice recording unit, a display unit, a sounding unit, a power source, a storage unit, and a control unit, wherein an input end of the video recording unit is connected to the storage unit; an output end of the voice recording unit is connected to the storage unit; an output end of the storage unit is connected to the display unit and the sounding unit; and the video recording unit, the voice recording unit, the display unit, the sounding unit, the power source, and the storage unit are all connected to the control unit.

2. The selfie short video greeting card of claim 1, wherein the power source comprises a rechargeable battery and a USB charging plug (4); and the USB charging plug (4) is connected to the rechargeable battery.

3. The selfie short video greeting card of claim 2, wherein the body is a paper shell (1); a first opening (12) and a second opening (13) are provided on an operating interface (11) of the paper shell (1); the display unit comprises a display screen located in the first opening (12); and the USB charging plug (4) is located in the second opening (13).

4. The selfie short video greeting card of claim 3, wherein the paper shell (1) is provided with a paper flip cover plate (2); one end of the paper flip cover plate (2) is integrally connected to the paper shell (1); when the paper flip cover plate (2) is folded, the paper flip cover plate (2) is fitted on the operating interface (11) of the paper shell (1); and when the paper flip cover plate (2) is unfolded, the paper flip cover plate (2) is separated from the operating interface (11) of the paper shell (1).

5. The selfie short video greeting card of claim 4, wherein the paper flip cover plate (2) is provided with a third opening (21) aligned with the first opening (12); and when the paper flip cover plate (2) is folded, an edge of the first opening (12) is flush with an edge of the third opening (21).

6. The selfie short video greeting card of claim 4, wherein the control unit comprises a circuit board, a first control key (5), and a second control key (6); the first control key (5) and the second control key (6) are both connected to the circuit board; the first control key (5) is configured to control device startup and video recording; the second control key (6) is configured to turn on the recorded video; and the first control key (5) and the second control key (6) are located at the operating interface (11) of the paper shell (1).

7. The selfie short video greeting card of claim 3, wherein the display screen is an LCD screen (3).

8. The selfie short video greeting card of claim 3, wherein the paper shell (1) is a hollow plate-like structure; the first opening (12) is located on an upper surface of the plate-like structure; and the second opening (13) is located on a side of the plate-like structure.
